(19) United States
(12) Patent Application Publication
(10) Pub. No.: US 2025/0174798 A1
(43) Pub. Date: May 29, 2025

(54) BATTERY FOR USE WITH A POWER TOOL

(71) Applicant: Techtronic Cordless GP, Anderson, SC (US)

(72) Inventors: Patrick Diana, Mooresville, NC (US); William J. Kozlowski, JR., Monroe, NC (US); Alexander Nader, Charlotte, NC (US); John Lea, Charlotte, NC (US); Raymond Lee Hei Man, Kwai Chung (HK); Marven Wang Nan, Guangdong (CN)

(21) Appl. No.: 18/422,123

(22) Filed: Jan. 25, 2024

(30) Foreign Application Priority Data
Nov. 28, 2023 (WO) PCT/CN2023/134839

(51) Int. Cl. H01M 50/247; H01M 10/48; H01M 50/213; H01M 50/262; H01M 50/271; H01M 50/296; H02J 7/00

(52) U.S. Cl. CPC H01M 50/247; H01M 10/488; H01M 50/213; H01M 50/262; H01M 50/271; H01M 50/296; H02J 7/0048; H01M 2220/30

(57) ABSTRACT

A battery for use with a power tool and the battery is removable from the power tool. The battery includes a housing having a first rib and a second rib. The battery further includes a release including an actuator and a latch that together move relative to the housing by the actuator from a first position to a second position. The release includes a first recess and a second recess, the first recess receives the first rib of the housing such that the first rib slides along the first recess to guide movement of the release between the first and second positions. The second recess receives the second rib of the housing such that the second rib slides along the second recess to guide movement of the release between the first and second positions.

### CROSS-REFERENCE TO RELATED APPLICATIONS

This application claims priority to International Application No. PCT/CN2023/134839, filed Nov. 28, 2023, the entire contents of which are hereby incorporated by reference herein.

### BACKGROUND

The present disclosure relates to batteries, particularly batteries that are configured for use with a power tool to provide power to the power tool.

### SUMMARY

In one embodiment the disclosure provides a battery configured for use with a power tool and the battery is removably coupled to the power tool. The battery includes a housing, the housing including a first rib and a second rib; a plurality of battery cells in the housing; and a terminal coupled to the plurality of battery cells, the terminal is configured to be removably coupled to the power tool to transfer power from the plurality of battery cells to the power tool. The battery further includes a release including an actuator and a latch that together move relative to the housing by the actuator from a first position to a second position. The battery configured to be secured to the power tool by the latch when the release is in the first position and the battery configured to be removed from the power tool when the release is in the second position. The release includes a first recess and a second recess, the first recess receives the first rib of the housing such that the first rib slides along the first recess to guide movement of the release between the first and second positions. The second recess receives the second rib of the housing such that the second rib slides along the second recess to guide movement of the release between the first and second positions.

In another embodiment, the disclosure provides a battery configured for use with a power tool and the battery removably coupled to the power tool. The battery includes a plurality of battery cells; a terminal coupled to the plurality of battery cells and configured to transfer power from the plurality of battery cells to the power tool; and a release including an actuator and a latch. The release is movable by the actuator from a first position to a second position. The battery is configured to be secured to the power tool by the latch when the release is in the first position and the battery configured to be removed from the power tool when the release is in the second position. The battery further includes a housing including a base and a lid. The base includes a recess that receives the plurality of battery cells and the lid is coupled to the base to enclose the recess and to enclose the plurality of battery cells within the housing. The housing includes a tongue and groove connection between the base and the lid and a plurality of fasteners that removably couple the base and the lid.

Other aspects of the disclosure will become apparent by consideration of the detailed description and accompanying drawings.

### BRIEF DESCRIPTION OF THE DRAWINGS

FIG. 1 is a perspective view of a battery according to one embodiment.

FIG. 2 is an alternative perspective view of the battery of FIG. 1.

FIG. 3 is a top side view of the battery of FIG. 1.

FIG. 4 is a cross-sectional view of the battery of FIG. 1 taking along line 4-4 in FIG. 3.

FIG. 5 is an enlarged portion of FIG. 4.

FIG. 6 is a perspective view of the battery of FIG. 1 with a portion of a lid of the battery removed.

FIG. 7 is a perspective view of a gasket of the battery of FIG. 1.

FIG. 8 is a perspective view of a portion of the lid of the battery of FIG. 1.

FIG. 9 is a perspective view of a release of the battery of FIG. 1.

FIG. 10 is a cross-sectional view of the battery of FIG. 1 taking along line 10-10 in FIG. 4.

FIG. 11 is alternative view of the cross-sectional view of FIG. 12

FIG. 12 is a cross-sectional view of the battery of FIG. 1 taken along line 12-12 in FIG. 4.

FIG. 13 is a perspective view of the battery of FIG. 1 with a portion of a housing of the battery removed.

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

### DETAILED DESCRIPTION

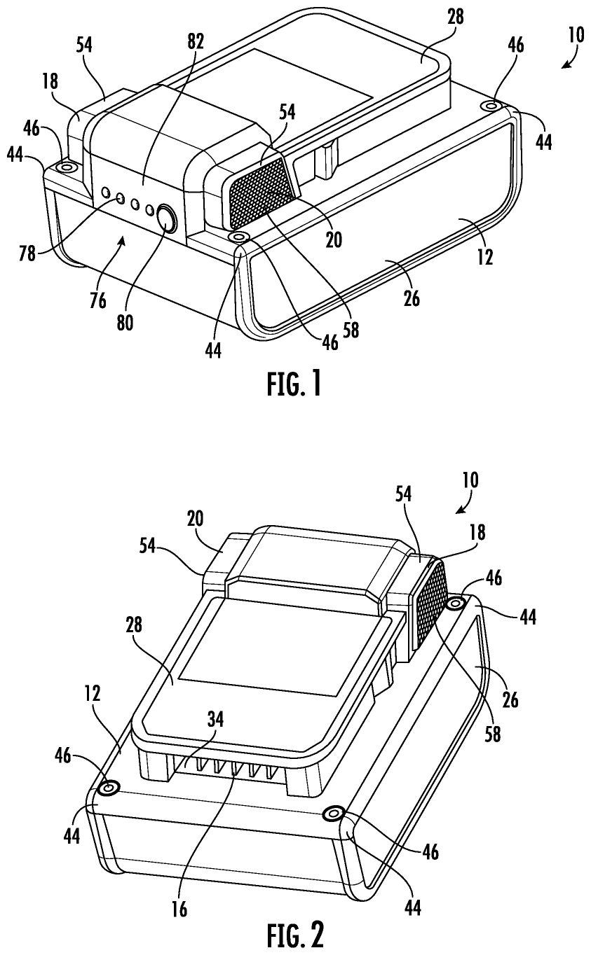

FIGS. 1 and 2 illustrate a battery 10 that is configured for use with a power tool. The power tool may include any tool that requires electrical power to operate, including vacuum cleaners, wet floor cleaners, drills, saws, cutters, cameras, etc. The battery 10 is removably coupled to the power tool so that the battery 10 can be replaced with a different battery while the battery 10 is being recharged.

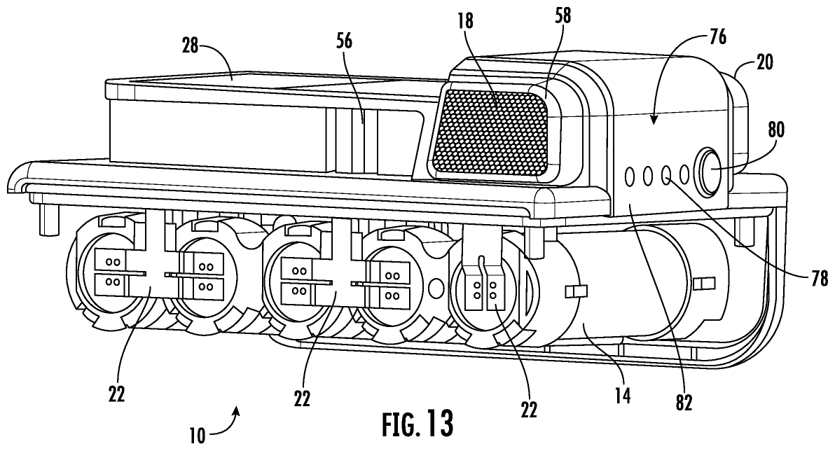

The battery 10 includes a housing 12, battery cells 14 (FIG. 13), terminals 16, a first release 18, and a second release 20. Referring to FIG. 13, the illustrated battery 10 includes five battery cells 14. In other embodiments, the battery 10 may include any suitable number of battery cells 14. The battery cells 14 are electrically connected by tabs 22. The battery cells 14 are rechargeable and may include any suitable type of battery cell, including lithium ion battery cells.

Referring to FIG. 6, the terminals 16 are electrically connected or coupled to the battery cells 14. The terminals 16 extend from a terminal base 38 that is connected to a circuit board 24 that controls operation of the battery 10. The terminals 16 are removably coupled to the power tool to transfer power from the battery cells 14 to the power tool. Also, the terminals 16 may connect the battery 10 and power tool to provide communication between the power tool and the circuit board 24.

Referring to FIGS. 2, 4, and 5, the housing 12 includes a base 26 and a lid 28. The base 26 includes a recess 30 that receives the battery cells 14. A groove 32 extends around a perimeter of the base 26. The illustrated perimeter of the base 26 is generally rectangular. The lid 28 is coupled to the base 26 to enclose the recess 30 and to enclose the battery cells 14 within the housing 12. The lid 28 includes an aperture 34. The terminals 16 extend through the aperture 34 to expose the terminals 16 so that the terminals 16 can be connected to terminals of the power tool.

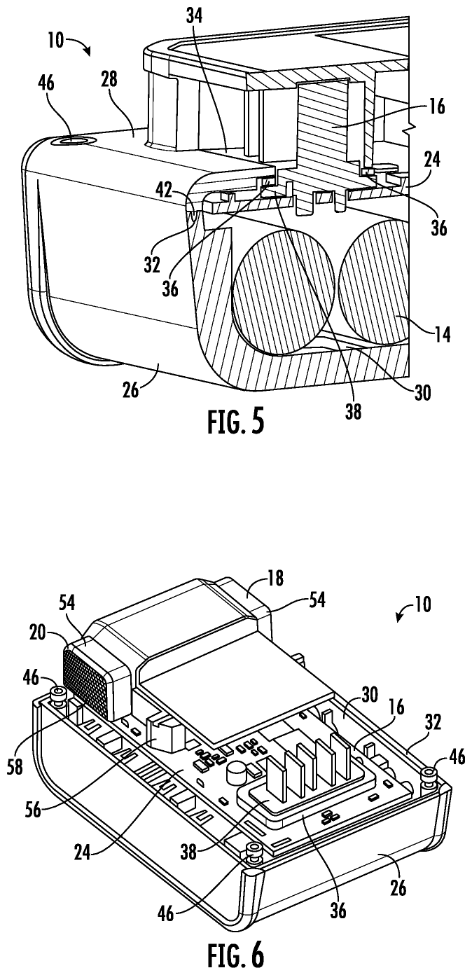

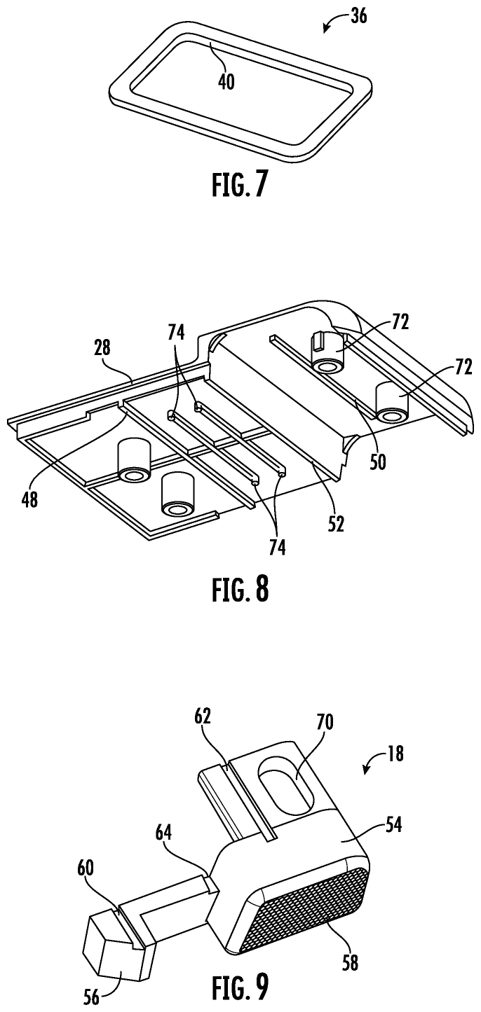

Referring to FIGS. 5-7, a gasket 36 is located between the lid 28 and the terminals 16 to seal an interface between the lid 28 and the terminals 16. The gasket 36 inhibits water and debris from passing through the aperture 34 and into the housing 12. The gasket 36 is directly connected to or seated on the terminal base 38 to seal an interface directly between the lid 28 and the terminal base 38. The gasket 36 is generally rectangular and includes an aperture 40. The gasket 36 surrounds the terminals 16 and the terminals 16 extend through the aperture 40 of the gasket 36. The gasket 36 can be formed from any suitable material, including rubber, silicone, and/or plastic.

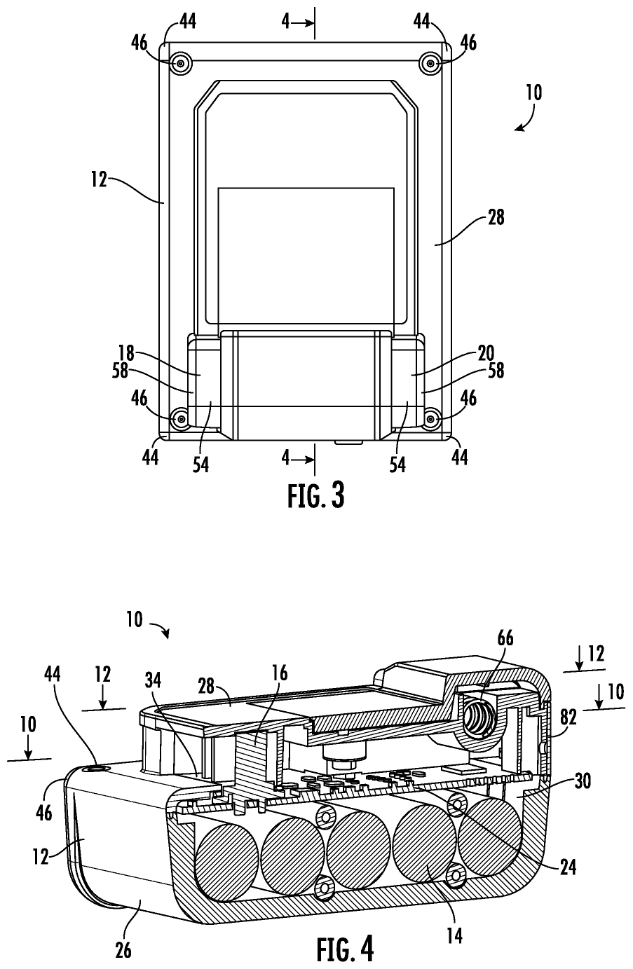

Referring to FIGS. 3 and 5, the lid 28 further includes a tongue 42 that extends around a perimeter of the lid 28. The tongue 42 is received in the groove 32 of the base 26 to form a tongue and groove connection between the base 26 and the lid 28. In the illustrated embodiment, the base 26 includes the groove 32 and the lid 28 includes the tongue, but in other embodiments, the base 26 may include the tongue 42 and the lid 28 may include the groove 32. In the illustrated embodiment, the tongue 42 is received directly in the groove 32 to create a direct connection between the base 26 and the lid 28 and no additional seals or gaskets are used between the base 26 and the lid 28 at the tongue and groove connection. The illustrated lid 28 is generally rectangular and includes corners 44. A fastener 46 is adjacent each corner 44. The fasteners 46 removably coupled the base 26 and the lid 28. In the illustrated embodiment, the battery 10 includes four fasteners adjacent each corner 44 of the lid 28. In one embodiment, the fasteners 46 include screws but in other embodiments, other types of fasteners can be used.

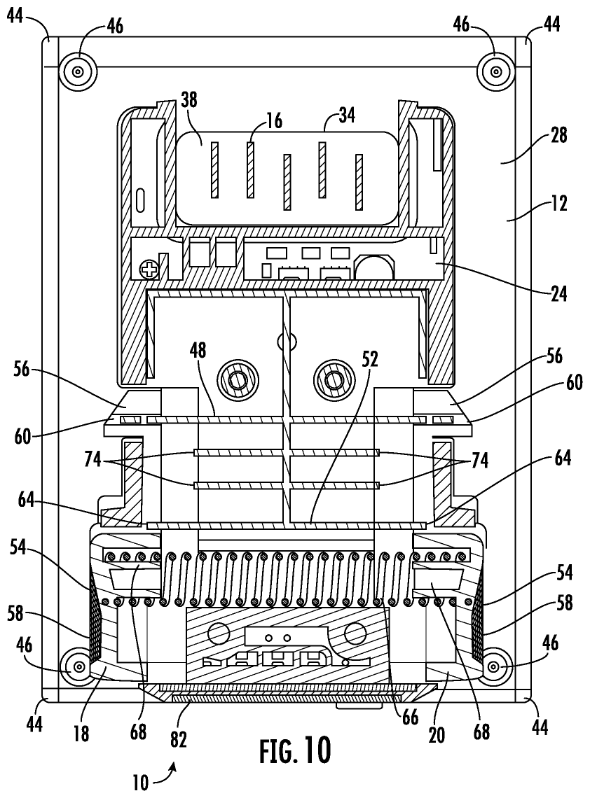

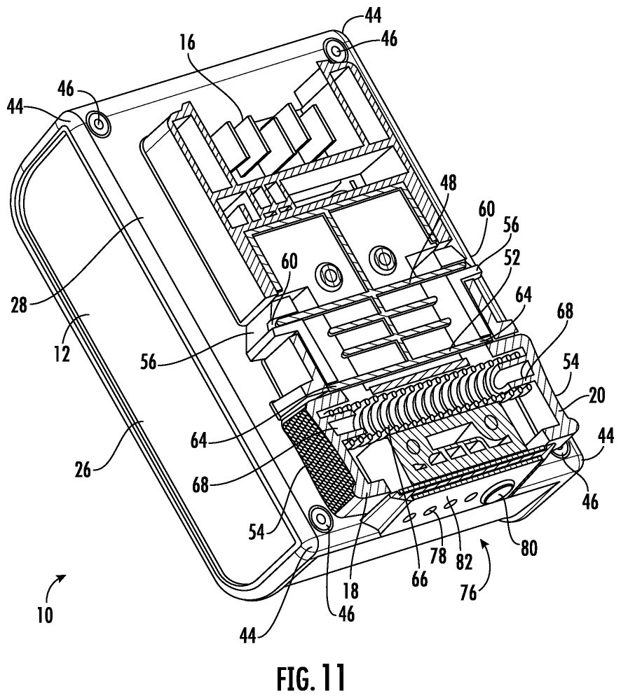

Referring to FIG. 8, the lid 28 further includes a first rib 48, a second rib 50, and a third rib 52 that guide movement of the first release 18 and the second release 20. The first release 18 and the second release 20 are movable between a first position and a second position. The first position is illustrated in FIG. 10. In the first position, the releases 18, 20 retain or secure the battery 10 to the power tool. In the second position, the releases 18, 20 allow the user to remove the battery 10 from the power tool, for example, by sliding the battery 10 relative to the power tool.

Referring to FIGS. 9 and 10, the first release 18 and the second release 20 include the same features and operation. Thus, only the first release 18 will be discussed in detail and like components of each release 18, 20 have been given the same reference number. The release 18 includes an actuator 54 and a latch 56. The actuator 54 includes a contact surface 58 that is pressed by a user to move the release 18 from the first position to the second position. The latch 56 is coupled to the actuator 54 to move relative to the housing 12 by the actuator 54 from the first position to the second position. In the first position of the release 18, the latch 56 extends outwardly from the housing 12 as shown in FIG. 10. In the second position of the release 18, the latch 56 is received within the housing 12 so that the latch 56 is disengaged from the power tool. In the illustrated embodiment, the release 18 is integrally formed as a single component.

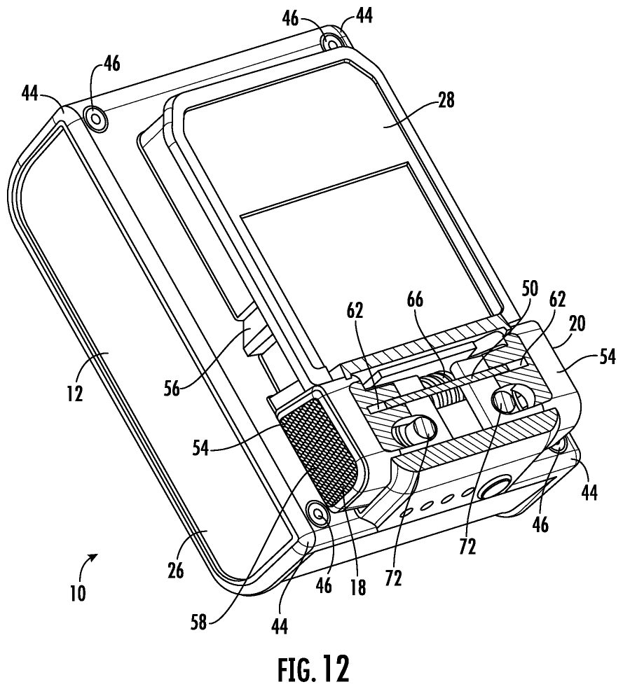

With continued reference to FIGS. 9 and 10, the first release 18 includes a first recess 60, a second recess 62, and a third recess 64. The first recess 60 receive the first rib 48 of the housing 12. The first rib 48 slides along the first recess 60 as the first release 18 moves between the first and the second positions to guide movement of the first release 18 between the first and the second positions. In the illustrated embodiment, the first recess 60 is located on the latch 56. The second recess 62 receives the second rib 50 (FIG. 12). The second rib 50 slides along the second recess 62 as the first release 18 moves between the first and the second positions to guide movement of the first release 18 between the first and the second positions. In the illustrated embodiment, the second recess 62 is located on the actuator 54. The third recess 64 receive the third rib 52. The third rib 52 slides along the third recess 64 as the first release 18 moves between the first and the second positions to guide movement of the first release 18 between the first and the second positions. In the illustrated embodiment, the third recess 64 is located between the actuator 54 and the latch 56. The second release 20 includes the same recesses 60, 62, 64 at the same locations and the ribs 48, 50, 52 also guide movement of the second release 20 between the first and second positions.

Referring to FIG. 10, a biasing member 66 biases the first release 18 and the second release 20 toward the first positions. The biasing member 66 extends from the first release 18 to the second release 20. In the illustrated embodiment, the releases 18, 20, each include a post 68 that extends into the biasing member 66 to couple the biasing member 66 to the releases 18, 20. In the illustrated embodiment, the biasing member 66 includes a coil spring. In other embodiments, other types of biasing members may be utilized. When the user moves the releases 18, 20 toward the second position, the user moves the releases 18, 20 against the force or bias created by the biasing member 66. The biasing member 66 automatically moves the releases 18, 20 back to the first positions when the actuators 54 are released by the user.

Referring to FIGS. 8 and 9, the releases 18, 20 further include an elongated aperture 70. The apertures 70 of the releases 18, 20 each receive a post 72 that extends through one of the apertures 70. The apertures 70 and posts 72 limit movement of the releases to the first and second positions and allow movement between the first and second positions of the releases 18, 20 while inhibiting movement beyond the first and the second positions. Also, the lid 28 includes stops 74. The stops 74 may abut the releases 18, 20 in the second position to also limit movement of the releases 18, 20 beyond the second position. The stops 74 are formed by ribs in the illustrated embodiment.

Referring to FIG. 1, the battery 10 further includes an interface 76. The interface 76 includes a display 78 and a button 80. The display 78 is operable to display a battery power level of the battery cells 14 in response to actuation of the button 80 by the user. In one embodiment the display 78 include a plurality of light emitting diodes and the number of diodes illuminated when the button 80 is pressed corresponds to the battery power level. The interface 76 further include an overlay 82. In one embodiment, the overlay 82 is a single layer and a single piece of material that covers both the button 80 and the display 78. In one embodiment, the overlay 82 is formed from silicon.

Various features and advantages of the are set forth in the following claims.

What is claimed is:

1. A battery configured for use with a power tool and the battery removably coupled to the power tool, the battery comprising:
a housing, the housing including a first rib and a second rib;
a plurality of battery cells in the housing;
a terminal coupled to the plurality of battery cells, the terminal configured to be removably coupled to the power tool to transfer power from the plurality of battery cells to the power tool; and
a release including an actuator and a latch that together move relative to the housing by the actuator from a first position to a second position, the battery configured to be secured to the power tool by the latch when the release is in the first position and the battery configured to be removed from the power tool when the release is in the second position, and
wherein the release includes a first recess and a second recess, the first recess receives the first rib of the housing such that the first rib slides along the first recess to guide movement of the release between the first and second positions, the second recess receives the second rib of the housing such that the second rib slides along the second recess to guide movement of the release between the first and second positions.

2. The battery of claim 1, wherein the latch of the release includes the first recess.

3. The battery of claim 1, wherein the actuator of the release includes the second recess.

4. The battery of claim 1, wherein the actuator includes a contact surface configured to be pressed by a user to move the release from the first position to the second position.

5. The battery of claim 1, wherein the housing includes a third rib and the release includes a third recess, the third recess receives the third rib of the housing such that the third rib slides along the third recess to guide movement of the release between the first and second positions.

6. The battery of claim 5, wherein the latch of the release includes the first recess, wherein the actuator of the release includes the second recess, and wherein the third recess is between the actuator and the latch.

7. The battery of claim 1, wherein the latch extends from the housing when the release is in the first position and the latch is received within the housing when the release is in the second position.

8. The battery of claim 1, wherein the release is a first release, the battery further comprising a second release, the second release including:
an actuator and a latch that together move relative to the housing by the actuator of the second release from a first position to a second position, the battery configured to be secured to the power tool by the latch of the second release when the second release is in the first position and the battery configured to be removed from the power tool when the second release is in the second position, and
wherein the second release includes a first recess and a second recess, the first recess of the second release receives the first rib of the housing such that the first rib slides along the first recess of the second release to guide movement of the second release between the first and second positions, the second recess of the second release receives the second rib of the housing such that the second rib slides along the second recess of the second release to guide movement of the second release between the first and second positions.

9. The battery of claim 8, further comprising a biasing member that biases the first and the second releases toward the first positions.

10. The battery of claim 1, further comprising an interface including a display and a button, the display operable to display a battery power level of the plurality of battery cells in response to actuation of the button, wherein the interface includes an overlay layer that covers the button and the display.

11. A battery configured for use with a power tool and the battery removably coupled to the power tool, the battery comprising:
a plurality of battery cells;
a terminal coupled to the plurality of battery cells and configured to transfer power from the plurality of battery cells to the power tool;
a release including an actuator and a latch, the release movable by the actuator from a first position to a second position, the battery configured to be secured to the power tool by the latch when the release is in the first position and the battery configured to be removed from the power tool when the release is in the second position;
a housing including a base and a lid, the base including a recess that receives the plurality of battery cells and the lid is coupled to the base to enclose the recess and to enclose the plurality of battery cells within the housing;
a tongue and groove connection between the base and the lid; and
a plurality of fasteners that removably couple the base and the lid.

12. The battery of claim 11, wherein the lid includes the tongue and the base includes the groove, and wherein the tongue is received within the groove.

13. The battery of claim 11, wherein the tongue extends around a perimeter of the lid and the groove extends around a perimeter of the base.

14. The battery of claim 11, wherein the tongue is directly coupled to the groove.

15. The battery of claim 11, wherein the plurality of fasteners include screws.

16. The battery of claim 11, wherein the lid is rectangular having a plurality of corners, and wherein the plurality of fasteners include a screw adjacent each corner of the lid.

17. The battery if claim 11, wherein the lid includes an aperture and wherein the terminal extends through the aperture of the lid to expose the terminal for connection to the power tool.

18. The battery of claim 17, further comprising a gasket between the lid and the terminal to seal an interface between the lid and the terminal.

19. The battery of claim 18, wherein the terminal extends through the gasket.

20. The battery of claim 11, wherein the housing including a first rib and a second rib, wherein the release includes a first recess and a second recess, the first recess receives the first rib of the housing such that the first rib slides along the first recess to guide movement of the release between the first and second positions, the second recess receives the second rib of the housing such that the second rib slides along the second recess to guide movement of the release between the first and second positions.
